(19) United States
(12) Patent Application Publication
(10) Pub. No.: US 2023/0205980 A1
(43) Pub. Date: Jun. 29, 2023

(54) MULTIDIRECTIONAL GENERATIVE EDITING

(71) Applicant: Microsoft Technology Licensing, LLC, Redmond, WA (US)

(72) Inventors: Christopher John BROCKETT, Kirkland, WA (US); Michel GALLEY, Seattle, WA (US); William B. DOLAN, Kirkland, WA (US)

(73) Assignee: Microsoft Technology Licensing, LLC, Redmond, WA (US)

(21) Appl. No.: 17/563,870

(22) Filed: Dec. 28, 2021

(51) Int. Cl. G06F 40/166; G06F 40/197; G06N 20/00

(52) U.S. Cl. CPC G06F 40/166; G06F 40/197; G06N 20/00

(57) ABSTRACT

Aspects of the present disclosure relate to multidirectional generative editing. In examples, content of a source document is used to produce generated content for a target document. A subpart of the source document may be associated with a subpart of the target document that includes the generated content. As a result of the association, if the subpart of the target document is modified (e.g., to add, remove, or edit natural language content or formatting), the subpart of the target document is used to produce generated content with which to update the source document accordingly. Thus, changes to generated content may be propagated back to a source document from which the generated content was produced.

### BACKGROUND

A user may edit generated content, for example to revise and/or update the generated content. However, this may cause other associated content to be outdated or otherwise inconsistent with the revised and/or updated generated content.

It is with respect to these and other general considerations that embodiments have been described. Also, although relatively specific problems have been discussed, it should be understood that the embodiments should not be limited to solving the specific problems identified in the background.

### SUMMARY

Aspects of the present disclosure relate to multidirectional generative editing. In examples, content of a source document is used to produce generated content for a target document. A subpart of the source document may be associated with a subpart of the target document that includes the generated content. As a result of the association, if the subpart of the target document is modified (e.g., to add, remove, or edit natural language content or formatting), the subpart of the target document is used to produce generated content with which to update the source document accordingly. Thus, changes to generated content may be propagated back to a source document from which the generated content was produced.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an overview of an example system for multidirectional generative editing according to aspects described herein.

FIG. 2 illustrates an overview of an example block diagram for multidirectional generative editing according to aspects described herein.

FIG. 3 illustrates an overview of an example method for updating source content based on user input associated with generated content according to aspects described herein.

FIG. 4 illustrates an overview of an example method for associating content subparts for multidirectional generative editing according to aspects described herein.

FIG. 5 illustrates an overview of an example method for processing user input to update an associated content subpart according to aspects described herein.

FIG. 6 illustrates an overview of an example method for locking a content subpart and processing associated user input according to aspects described herein.

FIG. 7 is a block diagram illustrating example physical components of a computing device with which aspects of the disclosure may be practiced.

FIGS. 8A and 8B are simplified block diagrams of a mobile computing device with which aspects of the present disclosure may be practiced.

FIG. 9 is a simplified block diagram of a distributed computing system in which aspects of the present disclosure may be practiced.

FIG. 10 illustrates a tablet computing device for executing one or more aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Embodiments may be practiced as methods, systems or devices. Accordingly, embodiments may take the form of a hardware implementation, an entirely software implementation, or an implementation combining software and hardware aspects. The following detailed description is therefore not to be taken in a limiting sense, and the scope of the present disclosure is defined by the appended claims and their equivalents.

In examples, multiple documents may each have associated content. For example, a presentation document may include one or more slides having content that is related to the content of a word processing document. In some instances, a generative transformer model is used to produce generated content from source content. For instance, the word processing document may be used as a source from which generated content is produced for inclusion in the presentation document. However, if a user revises, updates, or otherwise edits the presentation document, such a “unidirectional” relationship from the word processing document (as the content source) to the presentation document may mean that the word processing document is no longer consistent with the presentation document. For example, the word processing document may be outdated or may include incorrect information, among other examples. Thus, while unidirectional content generation may facilitate a user's preparation of the presentation document, a user may be frustrated when additional content and/or edits are introduced to the presentation document that are not propagated to the source document accordingly.

As an example, a presentation document may be created in conjunction with one or more documents of various kinds. For example, a journal article or white paper may be accompanied by a presentation document. As another example, a presentation document may become the source of a document, such as a formally written document (e.g., for archival record) and/or an “oral text” designed to be spoken by a user or using text-to-speech technology to an audience. These documents and media are normally created in sequential fashion, making them difficult to update and synchronize between iterations of editing, especially when multiple people may be participating in creating the content.

Accordingly, aspects of the present disclosure relate to multidirectional generative editing. In examples, generated content is produced based on a source document and included in another document (which may be referred to herein as a “target document”). In some instances, subparts of the source document and the target document are associated with each other. Returning to the example where a word processing document is used to generate at least a part of a presentation document, a paragraph of the word processing document may be associated with a slide of the presentation document. In other examples, subparts may be associated as a result of a user indication to associate one or more subparts of a first document with one or more subparts of another document. As a result, if user input associated with the slide is received (e.g., an edit, an addition, or an omission), the association between the paragraph of the word processing document and the slide of the presentation document may be used to produce generated content with which to update the paragraph of the word processing document accordingly.

Thus, rather than the user manually revising the word processing document to propagate associated changes from the presentation document, changes to the presentation document may instead be used in conjunction with a generative machine learning model to produce generated content with which to update the word processing document accordingly. As a result, a corresponding document will receive contextual changes that are dynamically generated to represent the content within the corresponding document (e.g., a paragraph may become a new bullet on a slide). In some instances, the generated content may be presented to the user as a suggested update to the word processing document or, as another example, the generated content may automatically be used to update the word processing document. This may improve the user experience offered by a set of applications (e.g., including word processing application and a presentation application, among any of a variety of alternative and/or additional applications), may reduce the amount of time associated with drafting such documents, and may decrease the potential for human error when drafting and revising documents, among other examples.

As used herein, a document includes any of a variety of types of content. Example content includes, but is not limited to, written and/or recorded language (which may also be referred to herein as “natural language” input or output), code (which may also be referred to herein as “programmatic output”), images, video, audio, gestures, visual features, intonation, contour features, poses, styles, fonts, and/or transitions, among other examples. Thus, as an example, content of a presentation document includes natural language content, as well as styles, fonts, and/or transitions, among other examples. User input associated with a document may therefore be associated with one or more types of content.

A subpart of a first document may be associated with a subpart of a second document. As used herein, a subpart or content subpart may refer to one or more sentences, paragraphs, pages, slides, graphs, cells, and/or images, among other examples. As noted above, content and, by extension, subparts need not be limited to a single content type. Further, a first subpart need not include the same or a similar amount of content as compared to a second subpart with which the first subpart is associated. For example, a first subpart of a word processing document may include a page of content, while a second subpart of a presentation document may include a slide. Even so, the slide of the presentation document may have semantically similar content to the page of the word processing document. As another example, a subpart may be substantially all of a document, as may be the case when a word processing document is generated based at least in part on a spreadsheet document. In some instances, a document may include subparts that are associated with multiple different documents. For example, a first subpart may be associated with a first set of documents, while a second subpart may be associated with a second set of documents, where at least some of the documents may differ between the first and second sets of documents.

Any of a variety of techniques may be used to associate subparts between documents. For example, a subpart in a first document may include metadata indicating an association with a subpart of a second document. The metadata may include a reference to the second document and/or a unique identifier associated with the subpart in the second document, among other examples. As another example, metadata may be maintained for a set of documents, where an association table for the set of documents stores an association between subparts of one or more documents. It will be appreciated that an association need not be limited to two documents and may associate constituent subparts of any number of documents. Further, an association need not be restricted to a single and/or contiguous subpart of a document and may instead indicate an association for any of a number of content subparts and/or a variety of content arrangements within a given document. For example, a first and a last slide of a presentation document may be associated with a title page of a word processing document.

Further, it will be appreciated that while examples are described with reference to a “source document” and a “target document,” such terms are not mutually exclusive with reference to a given document. Returning to the above example where the word processing document is a source document, it will be appreciated that the presentation document may be used as a source document to produce generated content for the word processing document, as may be the case if content is added to the presentation document that may then be propagated to the word processing document (e.g., now acting as a target document) according to aspects described herein. As such, given a document may function as both a source document and a target document in different scenarios, there may not be a “primary” document. Rather, a set of associated documents may instead each capture similar semantic meaning, with changes propagated among each other as a result of the techniques described herein.

Changes may be propagated as generated content according to aspects described herein. For example, natural language output may be used to update the content of a document accordingly. However, it will be appreciated that propagated changes need not be fully formed or “complete” such that they match the document for which the generated content is produced. For example, a placeholder, reminder, comment, or partial description may be produced and used to update a document. As another example, generated content may be incorporated into a document for user approval, as described herein. Thus, it will be appreciated that a variety of changes may be propagated so as to assist a user in the drafting process.

In other examples, a single “metadocument” may act as a primary or source document that stores semantic information from which each document in the set of documents is generated. Thus, each document of the set of documents may include a different representation of the semantic information captured by the metadocument. In such an example, received user input associated with a document of the set of documents may be used to update the metadocument, such that other documents of the set of documents are updated based on the updated metadocument accordingly. In some examples, rather than a metadocument having a set of associated documents, the metadocument itself may be opened in any of a variety of applications, such that a representation associated with a given application is presented accordingly. Thus, the metadocument may include or otherwise be used to generate content for any of a variety of applications and to propagate changes to other representations accordingly.

In examples, the metadocument includes content associated with such applications that is differentially stored (e.g., using a markup language and/or associated metadata), which can be read by the various applications. As another example, a single application may present multiple connected panes (e.g., each displaying content of the metadocument as a given document type), thereby enabling a user to export the content differentially (e.g., as either a text document, a presentation document, and/or a spreasheet document).

A set associated of documents may include documents for any of a variety of applications. For example, each document of the set of documents may be associated with a different application or a different type of application. Returning to the above example, the set of associated documents includes a document associated with a word processing application and a presentation application. Other example applications include, but are not limited to, a spreadsheet application, a mail application, a calendaring application, a task application, a blogging application, a speech-to-text application, a diagramming application, a development application (e.g., a code editor or integrated development environment), and/or a three-dimensional (3D) application (e.g., a video game application or an application for computer-aided design), among other examples. It will be appreciated that an application need not be limited to a single application type (and associated content types) and may incorporate functionality from any of a variety of these and other example applications. In other examples, it will be appreciated that a set of documents may include documents associated the same application or a similar type of application.

As noted above, generated content may be produced using a generative transformer model (e.g., using content of a source document and/or to propagate changes from a first document to a second document). The generative transformer model may have been trained using training data associated with any of a variety of modalities. Such a machine learning model may be referred to herein as a multimodal machine learning model. For example, a multimodal machine learning model may be trained using training data associated with word processing documents and presentation documents, thereby enabling the multimodal machine learning model to process and ultimately generate content associated with any combination of word processing content and presentation content.

As another example, a multimodal machine learning model may be trained using email and/or other electronic messaging content, which may include various descriptions of associated attachments having one or more associated application types and/or content types. A multimodal machine learning model may be associated with any number of modalities. For example, aspects described herein may use a set of multimodal machine learning models, where each model has an associated application pair. In examples where a set of documents is associated with a word processing application, a presentation application, and a spreadsheet application, example application pairs include (word processing application, presentation application), (word processing application, spreadsheet application), and (presentation application, spreadsheet application).

Thus, when producing generated content for the presentation application based on source content of the spreadsheet application (or vice versa), the multimodal machine learning model associated with the (presentation application, spreadsheet application) multimodal machine learning model may be used. In other instances of the above example, the same multimodal machine learning model may be used for each of the three applications, as may be the case when the multimodal machine learning model is trained using training data associated with each of the above example modalities. It will be appreciated that the content used to produce generated content need not be limited to natural langauge content. For example, a color scheme for a presentation slide might be used as a feature to adjust the tone of generated content for a document (and vice versa). Similarly, an image in a document may be processed according to aspects described herein, such that changing the color of an image may cause associated natural langauge content to be updated (e.g., for semantic content and/or mood) and vice versa.

In some instances, source content may be provided to a multimodal machine learning model in association with a prompt, where the prompt includes an indication of a target modality for which the generated output should be produced. For example, the prompt may comprise an indication that the generated output is for a spreadsheet application or may include an indication of specific functionality of the target application that is usable to affect the behavior of the target application accordingly, such as one or more application programming interface (API) functions and/or associated documentation.

Generated content produced using a multimodal machine learning model may comprise any of a variety of content, such as natural language output and/or programmatic output, among other examples. The multimodal output may be processed and used to affect content of an associated application, for example to add the generated content in association with the content subpart of the source document or to update content of the document, among other examples. For example, at least a part of the multimodal output may be executed or may be used to call an API of the application. Thus, processing the generated content may cause the application to affect content of the document, including natural language, styles, fonts, and/or transitions therein, among other examples.

As noted above, a user may be prompted to accept, reject, or revise generated content prior to its inclusion in a document. In other examples, generated content may automatically be used to propagate changes to an associated document. In some instances, a user may “lock” one or more content subparts, thereby preventing or otherwise limiting the use of generated content to affect the locked content subparts. For example, if a user determines that a content subpart is accurate, final, or should otherwise remain unchanged, the user may actuate a user interface element or provide another indication that the content subpart should be locked. In another example, the content subpart may be locked as a result of a user approving the generated content for inclusion in the document. As a result, user input received in association with another content subpart (e.g., of another associated document) may cause the locked content subpart to remain unchanged.

It will be appreciated that a lock may lock one or more aspects of a content subpart, such as natural language, formatting, and/or transitions, among other examples. Thus, a user may lock a style of a content subpart, while natural language content of the subpart may change based on a change to an associated document according to aspects described herein.

In some instances, an indication may be presented to the user that a change was made to a subpart associated with the locked subpart, such that the user may provide an indication to unlock the locked content subpart or to temporarily override the lock, among other examples. In some instances, a lock may be unidirectional, such that a change to a locked content subpart may still propagate a change to an associated subpart that is not locked. In other instances, a lock may be multidirectional. A user may specify whether a lock is unidirectional or multidirectional and, if the lock is multidirectional, the user may specify a set of documents and/or content subparts to which the lock applies. As another example, a user may remove an association between multiple subparts, such that changes to one or more of the subparts do not affect other previously associated subparts. Locks, associations, and other metadata may be stored in association with one or more documents, for example using Extensible Markup Language (XML) or JavaScript Object Notation (JSON), among other examples.

While examples are described herein with respect to a word processing application, a presentation application, and/or a spreadsheet application, it will be appreciated that aspects of the present disclosure may be applied to any of a variety of additional or alternative modalities. For example, a transcript and/or recording may be generated as a user presents a presentation document. Subparts of the transcript/recording may be associated with subparts of the presentation (e.g., based on when a user transitions between slides and/or content therein). As a result of the associations between the transcript/recording and the presentation, a revision to the presentation document may be suggested (e.g., as a result of producing generated content based on a transcript/recording subpart), thereby enabling a user to update the presentation document as a result of variations in the associated “oral text.” As another example, changes to the presentation document may be used to produce generated content with which to revise the transcript/recording, for example to provide, update, or remove stage directions or to revise a user's intonation, among other examples.

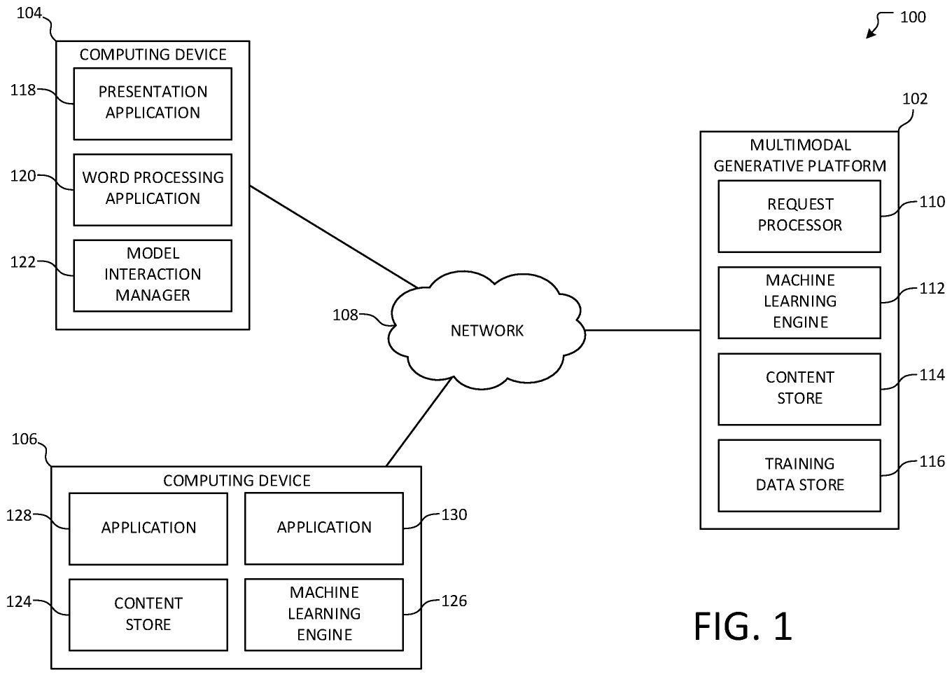

FIG. 1 illustrates an overview of an example system 100 for multidirectional generative editing according to aspects described herein. As illustrated, system 100 comprises multimodal generative platform 102, computing device 104, computing device 106, and network 108. In examples, multimodal generative platform 102, computing device 104, and/or computing device 106 communicate via network 108, which may comprise a local area network, a wireless network, or the Internet, or any combination thereof, among other examples.

While system 100 is described in an example where processing is performed using a machine learning model that is remote to computing device 104 (e.g., at multimodal generative platform 102), it will be appreciated that, in other examples, at least some aspects described herein with respect to multimodal generative platform 102 may be performed locally to computing device 104. Computing device 106 and associated aspects are discussed in detail below to provide one such example.

As illustrated, computing device 104 includes presentation application 118 and word processing application 120, each of which may be used to author and/or edit documents having one or more associated content types. For example, presentation application 118 may be used to author a presentation document, while word processing application 120 may be used to author a word processing document. In examples, a user manually authors a document by providing user input to add, revise, and/or remove content therein. In other examples, at least a part of the content may be programmatically generated, for example as a result of a user-provided prompt which may be used to produce generated content (e.g., by machine learning engine 112) accordingly. Thus, it will be appreciated that a document may include content as a result of any of a variety of techniques.

Model interaction manager 122 communicates with multimodal generative platform 102 to produce generated content according to user interactions received by presentation application 118 and word processing application 120. For example, as a result of a user editing a document in presentation application 118, model interaction manager 122 may cause an associated document to be updated by providing an indication of a content subpart associated with the received user input to multimodal generative platform 102, such that generated content is received in response. The received generated content may be included in a word processing document associated with word processing application 120 (e.g., automatically and/or in response to a user accepting or revising the generated content), for example as a result of an association between the edited content subpart and a subpart of the word processing document. In examples, at least a part of a presentation document of presentation application 118 and at least a part of word processing document of word procession application 120 are contemporaneously displayed by computing device 104, thereby enabling a user to edit one document and view the resulting changes in the other document.

In another example, model interaction manager 122 causes a new target document to be generated and associated with a source document. For example, model interaction manager 122 may provide content of the source document to multimodal generative platform 102, in response to which generated output may be received. As another example, the target document may be stored in content store 114 of multimodal generative platform 102 and the indication may comprise an identifier associated with the document. The target document may be generated accordingly, and subparts of the target document may be associated with the source document according to aspects described herein.

In examples, model interaction manager 122 may process the generated output to affect the behavior of application 118 and/or application 120 according to aspects described herein. For example, the generated output may include any of a variety of types of content, each of which may affect certain aspects of an application. As an example, the generated output may include programmatic output, which may be executed, parsed, or otherwise processed by model interaction manager 122 (e.g., as one or more API calls or function calls to presentation application 118 and/or word processing application 120). As another example, the model output may include natural language output, which may be incorporated into a document (e.g., automatically and/or as a result of a user indication accepting the generated output). In some instances, the generated natural language output received from multimodal generative platform 102 may itself include formatting and/or have applied styles, among other examples.

As noted above, the generated output may affect any of a variety of other aspects of application 118 and/or 120, for example relating to styles, formatting, and/or transitions, among other examples. Thus, while example processing and associated content types are described, it will be appreciated that model interaction manager 122 may use any of a variety of techniques to process generated output produced by a multimodal machine learning model according to aspects of the present disclosure.

Computing device 106 is similarly illustrated as comprising application 128 and application 130. Application 128 and application 130 may each be any of a variety of applications. In examples, application 128 and application 130 are each a different type of application having a different set of associated content types. In contrast to computing device 104, computing device 106 does not include model interaction manager 122 and is illustrated as comprising machine learning engine 126. Thus, computing device 106 is provided as an example in which at least a part of aspects described herein with respect to producing generated content are performed local to computing device 106. For example, machine learning engine 126 may be used to produce generated output for a target document associated with application 130 based on a source document associated with application 128 (or vice versa, in other examples). Such aspects are similar to those discussed with respect to presentation application 118, word processing application 120, model interaction manager 122, and machine learning engine 112 and are therefore not necessarily re-described.

While computing devices 104 and 106 are illustrated as each comprising two applications, it will be appreciated that any number of applications may be used in other examples. Further, aspects described herein may be performed using any number of computing devices. For example, a user may edit a word processing document using word processing application 120 of computing device 104 and an associated document may be edited using application 128 of computing device 106.

Documents edited by applications 118, 120, 128, and 130 may be stored locally to one or more of computing devices 104 and 106 (e.g., in content store 124) and/or may be stored by multimodal generative platform 102 (e.g., in content store 114), as may be the case when multimodal generative platform 102 facilitates collaborative document editing. For example, computing device 104 and/or computing device 106 may each include a web browser application, which may be used to access a collaborative editing web application of multimodal generative platform 102 (e.g., as may be provided by request processor 110). In such examples, user input associated with a document of the collaborative editing web application may be used to produce generated content and update one or more other associated documents (e.g., as may similarly be stored by the multimodal generative platform 102 in content store 114). Thus, it will be appreciated that documents may be associated within one or more local content stores (e.g., content store 124), one or more remote content stores (e.g., content store 114), or any combination thereof.

Multimodal generative platform 102 is illustrated as comprising request processor 110, machine learning engine 112, content store 114, and training data store 116. In examples, request processor 110 receives a request from computing device 104 (e.g., from model interaction manager 122) to produce generated output (e.g., as may be generated by machine learning engine 112). For example, the request may include at least a part of a document, an indication of user input associated with a document, and/or a prompt as described above, among other examples. Accordingly, request processor 110 may use machine learning engine 112 to produce generated output.

Machine learning engine 112 may comprise one or more multimodal machine learning models according to aspects described herein. For example, machine learning engine 112 may include a multimodal machine learning model that was trained using a training data set having a plurality of content types (e.g., associated with one or more applications, such as applications 118, 120, 128, and/or 130). Thus, given content associated with a first application (e.g., having one or more content types of a first set of content types), machine learning engine 112 may generate content associated with the first application and/or content of a second application (e.g., having one or more content types of a second set of content types). In such an example, it will be appreciated that the first and second sets of content types need not be mutually exclusive.

Multimodal generative platform 102 is illustrated as comprising content store 114, where one or more documents associated with applications 118, 120, 128, and/or 130 may be stored. For example, computing device 104 and/or computing device 106 may use an associated application to edit a document in content store 114, such that multimodal generative platform 102 may determine to update an associated document (e.g., as a result of an association between a content subpart of the edited document and a content subpart of the associated document). It will be appreciated that, in other examples, an application may be a web application provided by multimodal generative platform 102, such that a web browser application (not pictured) of computing device 104 and/or computing device 106 is used to access the web application and to edit one or more associated documents accordingly.

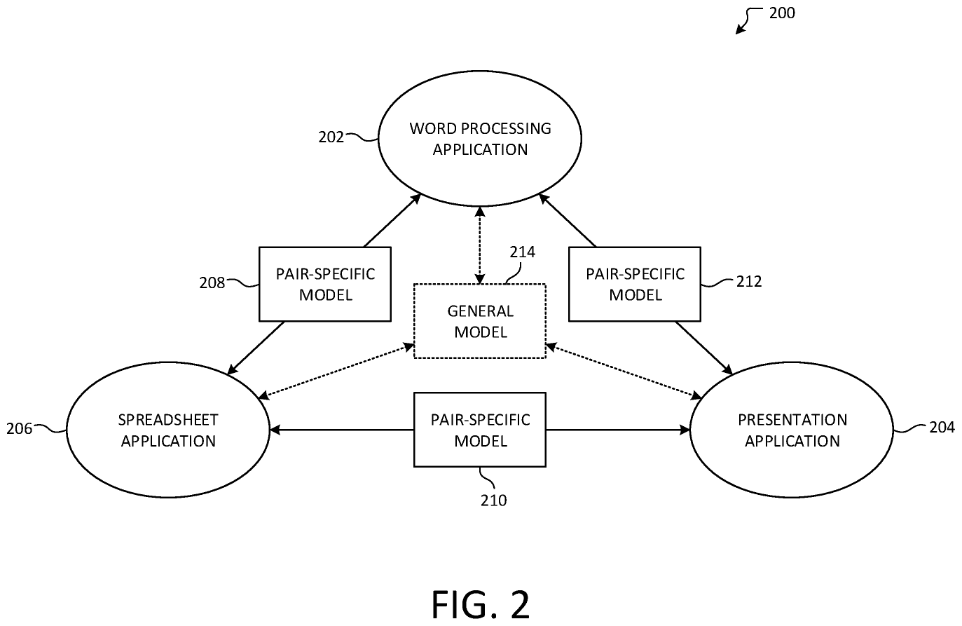

FIG. 2 illustrates an overview of an example block diagram 200 for multidirectional generative editing according to aspects described herein. As illustrated, block diagram includes word processing application 202, presentation application 204, and spreadsheet application. Aspects of applications 202, 204, and 206 may be similar to those discussed above with respect to applications 118, 120, 128, and/or 130 and are therefore not necessarily re-described below in detail.

In examples, word processing application 202 has an associated word processing document, presentation application 204 has an associated presentation document, and spreadsheet application 206 has an associated spreadsheet document, each of which include associated content subparts. For example, a subpart of the word processing document may be associated with a subpart of the presentation document and a subpart of the spreadsheet document. It will be appreciated that, in other examples, a document may have a subpart that is not associated with a subpart of another document or that is associated with only a subset of other documents.

Diagram 200 is further illustrated as including pair-specific models 208, 210, and 212. As illustrated, pair-specific model 208 is associated with word processing application 202 and spreadsheet application 206, pair-specific model 210 is associated with presentation application 204 and spreadsheet application 206, and pair-specific model 212 is associated with word processing application 202 and presentation application 204. Thus, each pair-specific model was trained using training data associated with a given pair of applications, thereby resulting in a multimodal machine learning model usable to produce generated content across two modalities. Accordingly, when producing generated content according to aspects described herein, an associated pair-specific model may be used.

For example, if a source document associated with word processing application 202 is used to produce generated content for presentation application 204, pair-specific model 212 may be used. Similarly, if the target document is used to produce generated content for spreadsheet application 206, pair-specific model 208 may be used. Thus, multiple pair-specific models may be used to produce generated content for a set of documents based on a source document.

Similar techniques may be used to update an associated content subpart. In the above example, a subpart of the source word processing document is associated with a subpart of a spreadsheet document and a subpart of a presentation document. Accordingly, if user input associated with the subpart of the spreadsheet document is received (e.g., via spreadsheet application 206), pair-specific model 208 may be used to update the associated subpart of the word processing document, while pair-specific model 210 may be used to update the associated subpart of the presentation document.

In other examples, general model 214 may be used. General model 214 may be trained using more general training data as compared to pair-specific models 208, 210, and 212. For example, general model 214 may have been trained using email and/or other electronic messaging content, which may include various descriptions of associated attachments having one or more associated application types and/or content types. Thus, as compared to a pair-specific model, general model 214 may produce generated content across additional modalities, for example producing generated content for both a word processing document and a spreadsheet document based on a presentation document.

In such examples, a prompt may be included with source content, thereby causing general model 214 to produce generated content for a given target document and associated target application accordingly. For instance, a first invocation of general model 214 may include a prompt to produce generated content for spreadsheet application 206, while a second invocation of general model 214 may include a prompt to produce generated application for word processing application 202.

While diagram 200 is illustrated as including three applications 202, 204, and 206, and associated models 208, 210, and 212, it will be appreciated that any number of applications and/or content types may be used in conjunction with any of a variety of machine learning models according to aspects described herein.

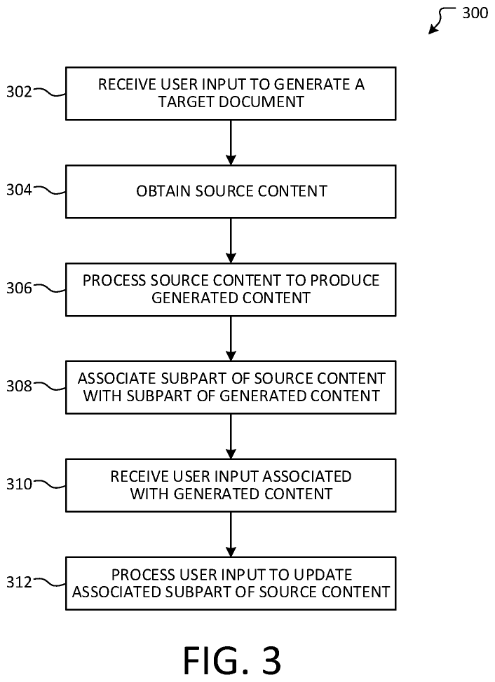

FIG. 3 illustrates an overview of an example method 300 for updating source content based on user input associated with generated content according to aspects described herein. In examples, aspects of method 300 are performed by a model interaction manager and/or an application, such as model interaction manager 122 and applications 120, 122, 128, and 130 discussed above with respect to FIG. 1.

Method 300 begins at operation 302, where user input is received to generate a target document. For example, user input may be received at a source application associated with a source document (e.g., application 120, 122, 128, or 130 discussed above with respect to FIG. 1) for which generated content is to be produced. As another example, the user input may be received at an application associated with the target document. For instance, a user may provide the source document to the target application so as to generate a target document based on the source document accordingly.

Moving to operation 304, source content is obtained. For example, source content may be obtained from a source document of the source application at which user input was received at operation 302, where the user has used the source application to author at least a part of the source document. In another example, at least a part of the source content may be generated content. In such an example, user input may be provided to a generative machine learning model, such that the machine learning model may have generated the source content accordingly. As another example, the user input received at operation 302 may include the source content. The source content may be one or more content subparts or an entire document, among other examples. Thus, it will be appreciated that source content may be obtained according to any of a variety of techniques.

At operation 306, the source content is processed to produce generated content. For example, a request may be provided to a multimodal generative platform (e.g., multimodal generative platform 102) that includes the source content that was obtained at operation 304. In some examples, the request may include a prompt indicating a target content type and/or a target application for which generated content should be produced. Accordingly, a response may be received from the multimodal generative platform that includes model output generated by a machine learning engine (e.g., machine learning engine 112). In other examples, a local machine learning engine may be used (e.g., machine learning engine 126 of computing device 106). As noted above, the generated content may include any of a variety of content types, as may be associated with the target application. In examples, operation 306 includes identifying a machine learning model with which to produce the generated content from a set of machine learning models (e.g., pair-specific models 208, 210, and 212 discussed above with respect to FIG. 2). In other examples, a general machine learning model may be used (e.g., general machine learning model 214).

Operation 306 may include generating a new target document in which to store the generated content or, as another example, the generated content may be stored in a pre-existing document. In some instances, at least a part of the generated output may be processed, for example to invoke an API of the target application. Thus, it will be appreciated that any of a variety of operations may be performed to produce generated content in a target document according to aspects described herein.

Flow progresses to operation 308, where a subpart of the source content is associated with a subpart of the generated content. In examples, the source content obtained at operation 304 includes multiple subparts, each of which may have an associated subpart in the generated content. In some instances, model output produced by the generative multimodal machine learning model includes an indication as to an associated source content subpart for the generated content subpart. In other examples, generated content may be produced iteratively, where each source subpart is processed to generate one or more associated generated content subparts.

As noted above, any of a variety of techniques may be used to associate such subparts. For example, operation 308 may include updating metadata of a source document and/or a target document to indicate an association with a subpart of a corresponding document. As another example, an association table may be updated. It will be appreciated that method 300 is provided as an example where two documents (e.g., a source document and a target document) have associated subparts, however an association need not be limited to two documents include any number of documents. Further, an association need not be restricted to a single and/or contiguous subpart of a document and may instead indicate an association for any of a number of content subparts and/or a variety of content arrangements within a given document.

Moving to operation 310, user input associated with the generated content is received. The user may edit the generated content using an associated application (e.g., the target application). As an example, the user may add, remove, or edit the generated content (e.g., by adding natural language content or by changing a style or formatting). In examples, operation 310 may comprise determining that the user has finished providing user input associated with the source content. For example, a predetermined amount of time may elapse or an explicit user indication may be received, among other examples.

Accordingly, at operation 312, the user input is processed to update an associated subpart of the source content. For example, the associated subpart of source content may be determined using an association that was generated at operation 308. As discussed above, the association may be stored in the target document or in an association table, among other examples. In examples, operation 312 comprises providing an updated content subpart (e.g., as was updated as a result of the received user input at operation 310) to a multimodal generative platform (e.g., multimodal generative platform 102) or a local machine learning engine may be used (e.g., machine learning engine 126 of computing device 106).

Generated output may be produced based on the updated content subpart, which may be used to update the source content accordingly. For example, at least a part of the generated content may be executed to affect operation of an associated application. As another example, the generated content may be presented to the user for approval. In examples, the user may revise or reject the generated content. If the user approves the generated content, the source document (e.g., from which the source content was obtained at operation 304; now acting as a target document) may be updated accordingly. In other examples, the generated content may be automatically used to update the source document. Aspects of operation 312 are similar to those discussed above with respect to operation 306 and are therefore not necessarily re-described in detail. Method 300 ends at operation 312.

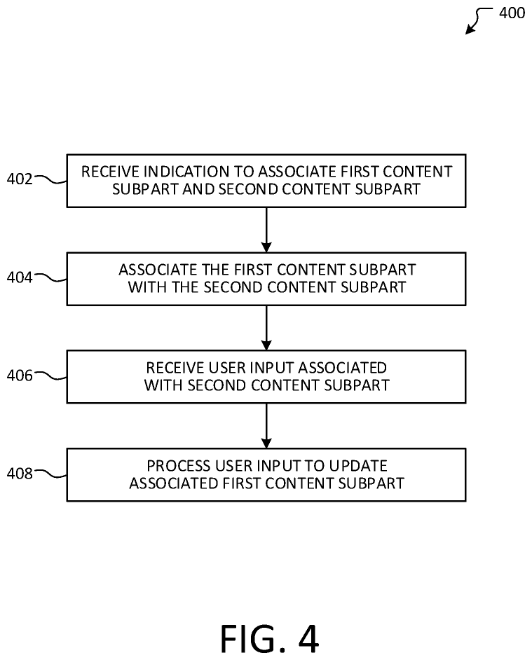

FIG. 4 illustrates an overview of an example method 400 for associating content subparts for multidirectional generative editing according to aspects described herein. For example, aspects of method 400 are performed using a set of pre-existing documents, as may be the case when a user has already authored the documents, each of which are related. In other examples, aspects of method 400 are performed to re-associate a set of documents, as may be the case when the user has previously unlinked the documents.

Method 400 begins at operation 402, where an indication is received to associate a first content subpart and a second content subpart. For example, the indication may be received at an application associated with the first content subpart and/or the second content subpart. For instance, the user may select the first content subpart in the application associated with the first content subpart. Similarly, the user may select the second content subpart in the application associated with the second content subpart. The user may then actuate a user interface element to associate the selected content subparts, among any of a variety of other user inputs. In some instances, a different application (e.g., other than an application associated with the content subparts) may receive the indication. In some examples, a user may actuate a user interface element to cause associations to automatically be determined, for example based on semantic similarity between subparts of the set of documents.

At operation 404, the first content and the second content subpart are associated. As noted above, any of a variety of techniques may be used to associate such subparts. For example, operation 404 may include updating metadata of a document including the first content subpart and/or the second content subpart to indicate the association with the corresponding subpart. As another example, an association table may be updated.

At operation 406, user input associated with the second content subpart is received. The user may edit the second content subpart using an associated application. As an example, the user may add, remove, or edit the content subpart (e.g., by adding natural language content or by changing a style or formatting). In examples, operation 406 may comprise determining that the user has finished providing user input associated with the source content. For example, a predetermined amount of time may elapse or an explicit user indication may be received, among other examples.

Accordingly, at operation 408, the user input is processed to update the first content subpart, for example as a result of the association generated at operation 404. In examples, the updated second content subpart may be provided to a multimodal generative platform (e.g., multimodal generative platform 102) or a local machine learning engine may be used (e.g., machine learning engine 126 of computing device 106).

Generated output may be produced based on the updated second content subpart, which may be used to update the first content subpart accordingly. For example, at least a part of the generated content may be executed to affect operation of an associated application. As another example, the generated content may be presented to the user for approval. In examples, the user may revise or reject the generated content. If the user approves the generated content, the first content subpart may be updated accordingly. In other examples, the generated content may be automatically used to update the first content subpart. Aspects of operation 408 are similar to those discussed above with respect to operations 306 and 312 in FIG. 3 and are therefore not necessarily re-described in detail. Method 400 ends at operation 408.

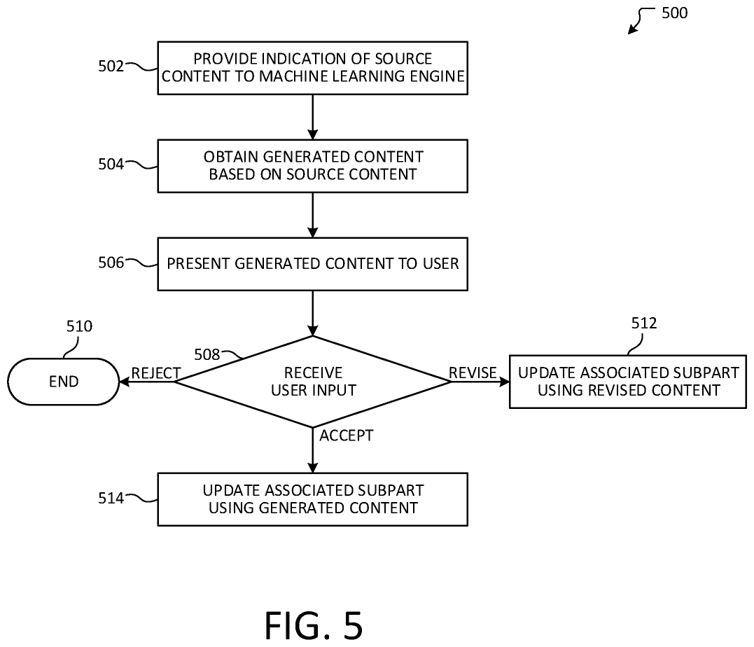

FIG. 5 illustrates an overview of an example method 500 for processing user input to update an associated content subpart according to aspects described herein. For example, aspects of method 500 may be performed as part of operations 306, 312, and 408 discussed above with respect to methods 300 and 400 in FIGS. 3 and 4, respectively.

At operation 502, an indication of source content is provided to a machine learning engine. For example, the source content may be provided to a local machine learning engine (e.g., machine learning engine 126 of computing device 106 in FIG. 1). As another example, the source content may be provided to a machine learning of a multimodal generative platform, such as multimodal generative platform 102. In some instances, the source content is provided with an indication as to a source application and/or a target application, such that a machine learning model may be selected from a set of multimodal machine learning models. In other examples, operation 502 comprises selecting a machine learning model from the set of machine learning models. In some instances, operation 502 comprises providing a prompt with which to produce the generated content.

At operation 504, generated content that is based on the source content is obtained. For example, the generated content have one or more content types associated with a target application and/or target document. In examples, at least a part of the content includes programmatic output that may be executed to affect the behavior of the target application.

At operation 506, the generated content is presented to the user. For example, the generated content may be presented separate from the target content that would be updated using the generated content. As another example, the generated content may be presented in association with the target content, for example as a content comparison to show changes to the target content in relation to the generated content. Thus, it will be appreciated that any of a variety of techniques may be used to present the generated content to the user.

At determination 508, user input is received. According to aspects described herein, user input may comprise an indication to reject the generated content, revise the generated content, or accept the generated content. Accordingly, if user input is received to reject the generated content, flow branches “REJECT” and ends at operation 510. In other examples, a user may revise the source content and/or a prompt, such that aspects of method 500 are performed to produce different generated content according to the revised source content and/or prompt.

Returning to determination 508, if user input is received to revise the generated content, flow branches “REVISE” to operation 512, where an associated subpart is updated according to the revised content. For example, the subpart may be determined based on an association with the source content according to aspects described herein. In examples, signals associated with a user's revisions may be stored as training data and used to improve model performance. For example, user corrections associated with different modalities may be used to train a multimodal machine learning model to favor certain content types, tones, and/or styles for a given modality (e.g., certain content may be better in a presentation context as compared to a spreadsheet context).

While method 500 is described in an example where a single content subpart is updated, it will be appreciated that similar techniques may be applied for any number of associated content subparts. For example, operation 504 may be performed multiple times so as to produce generated content for each associated content subpart. Method 500 terminates at operation 512.

Returning to determination 508, if user input is received to accept the generated content, flow branches “ACCEPT” to operation 514, where an associated subpart is updated based on the generated content. In examples, updating the associated subpart includes executing at least a part of the generated output. Aspects of operation 514 are similar to operation 512 and are therefore not necessarily re-described. Method 500 is provided as an example where user input is received prior to updating a content subpart according to generated content. It will be appreciated that, in other examples, at least some updates may be performed automatically. For example, content may be added to a target document automatically, while revisions or omissions may first request user confirmation. Method 500 terminates at operation 514.

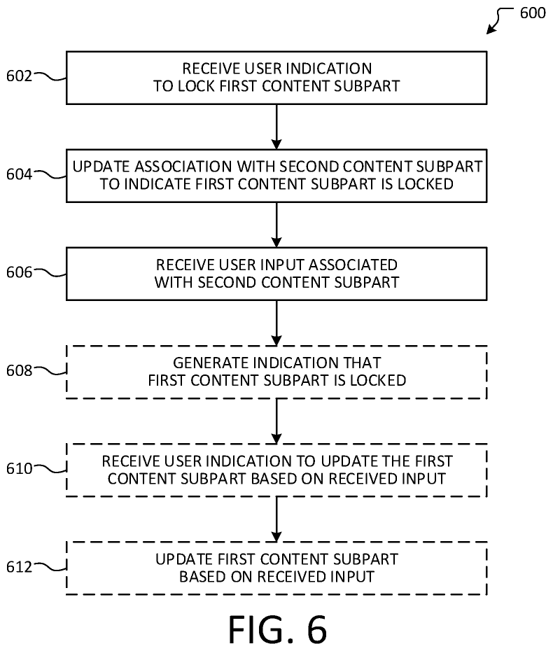

FIG. 6 illustrates an overview of an example method 600 for locking a content subpart and processing associated user input according to aspects described herein. In examples, aspects of method 600 are performed by an application, such as application 118, 120, 128, and/or 130 discussed above with respect to FIG. 1.

Method 600 begins at operation 602, where a user indication is received to lock a first content subpart. For example, the indication may be received as a result of a user actuating a user interface element of the application. In some instances, the user may select the first content subpart, thereby specifying that the content subpart is to be locked. In other examples, the user indication may be approval of generated content. Thus, it will be appreciated that any of a variety of user input may be received to lock a content subpart according to aspects described herein.

At operation 604, an association with a second content subpart is updated to indicate that the first content subpart is locked. As noted above, the lock may be unidirectional or multidirectional. In instances where there are multiple documents associated with the first content subpart, a user may be prompted to indicate a set of documents to which the lock applies. Operation 604 may include updating metadata associated with a document and/or updating an association table, among other examples.

Flow progresses to operation 606, where user input associated with the second content subpart is received. As noted above, a user may add, remove, or edit the second content subpart (e.g., by adding natural language content or by changing a style or formatting). In examples, operation 606 may comprise determining that the user has finished providing user input associated with the source content. For example, a predetermined amount of time may elapse or an explicit user indication may be received, among other examples.

At operation 608, an indication may be generated to indicate that the first content subpart is locked (e.g., as a result of operations 602 and 604 discussed above). For example, the indication may be an alert or a dialogue. As another example, the indication may be presented as a tooltip. It will therefore be appreciated that the indication may be presented using a variety of user experience paradigms. Operation 608 is illustrated using a dashed box to indicate that, in some examples, operation 608 may be omitted. For example, method 600 may terminate at operation 606, as may be the case when a user configures an application to not provide such indications.

In other examples, flow progresses to operation 610, where a user indication is received to update the first content subpart based on the input that was received at operation 606. For example, the indication presented at operation 608 may enable user input to indicate that a lock should temporarily be overridden or should be removed. Accordingly, flow progresses to operation 612, where the first content is updated based on the user input that was received at operation 606. Examples of such aspects were discussed above with respect to method 500 of FIG. 5 and operations 306, 312, and 408 discussed above with respect to methods 300 and 400 in FIGS. 3 and 4, respectively. Accordingly, they are not necessarily re-described in detail. Method 600 terminates at operation 612.

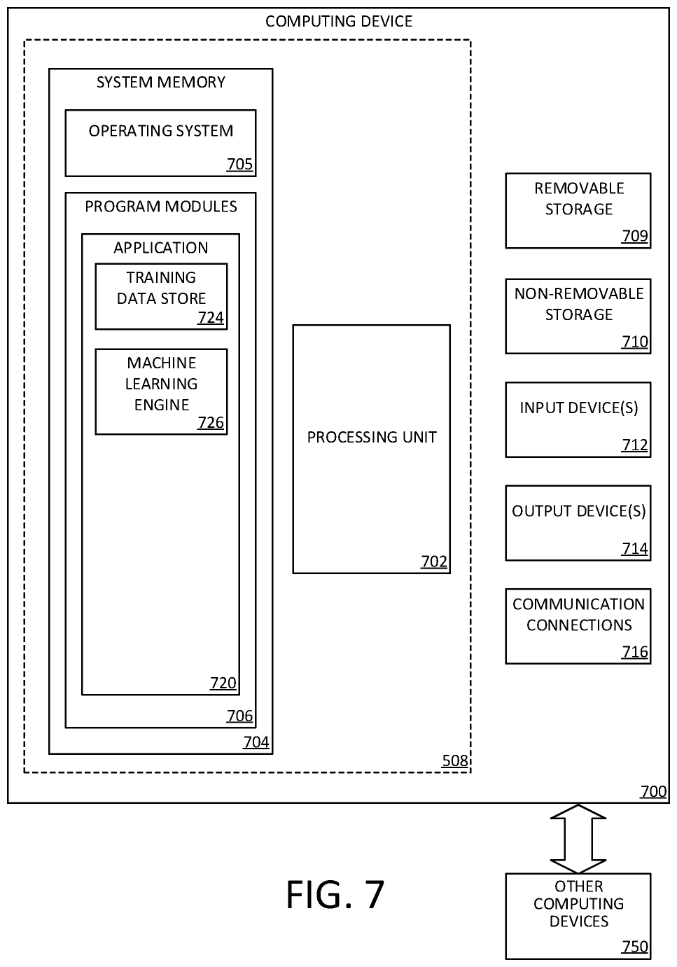

FIGS. 7-10 and the associated descriptions provide a discussion of a variety of operating environments in which aspects of the disclosure may be practiced. However, the devices and systems illustrated and discussed with respect to FIGS. 7-10 are for purposes of example and illustration and are not limiting of a vast number of computing device configurations that may be utilized for practicing aspects of the disclosure, described herein.

FIG. 7 is a block diagram illustrating physical components (e.g., hardware) of a computing device 700 with which aspects of the disclosure may be practiced. The computing device components described below may be suitable for the computing devices described above, including devices 104 and/or 106, as well as one or more devices associated with multimodal generative platform 102 discussed above with respect to FIG. 1. In a basic configuration, the computing device 700 may include at least one processing unit 702 and a system memory 704. Depending on the configuration and type of computing device, the system memory 704 may comprise, but is not limited to, volatile storage (e.g., random access memory), non-volatile storage (e.g., read-only memory), flash memory, or any combination of such memories.

The system memory 704 may include an operating system 705 and one or more program modules 706 suitable for running software application 720, such as one or more components supported by the systems described herein. As examples, system memory 704 may store training data store 724 and machine learning engine 726. The operating system 705, for example, may be suitable for controlling the operation of the computing device 700.

Furthermore, embodiments of the disclosure may be practiced in conjunction with a graphics library, other operating systems, or any other application program and is not limited to any particular application or system. This basic configuration is illustrated in FIG. 7 by those components within a dashed line 708. The computing device 700 may have additional features or functionality. For example, the computing device 700 may also include additional data storage devices (removable and/or non-removable) such as, for example, magnetic disks, optical disks, or tape. Such additional storage is illustrated in FIG. 7 by a removable storage device 709 and a non-removable storage device 710.

As stated above, a number of program modules and data files may be stored in the system memory 704. While executing on the processing unit 702, the program modules 706 (e.g., application 720) may perform processes including, but not limited to, the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 7 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 700 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 700 may also have one or more input device(s) 712 such as a keyboard, a mouse, a pen, a sound or voice input device, a touch or swipe input device, etc. The output device(s) 714 such as a display, speakers, a printer, etc. may also be included. The aforementioned devices are examples and others may be used. The computing device 700 may include one or more communication connections 716 allowing communications with other computing devices 750. Examples of suitable communication connections 716 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 704, the removable storage device 709, and the non-removable storage device 710 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 700. Any such computer storage media may be part of the computing device 700. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

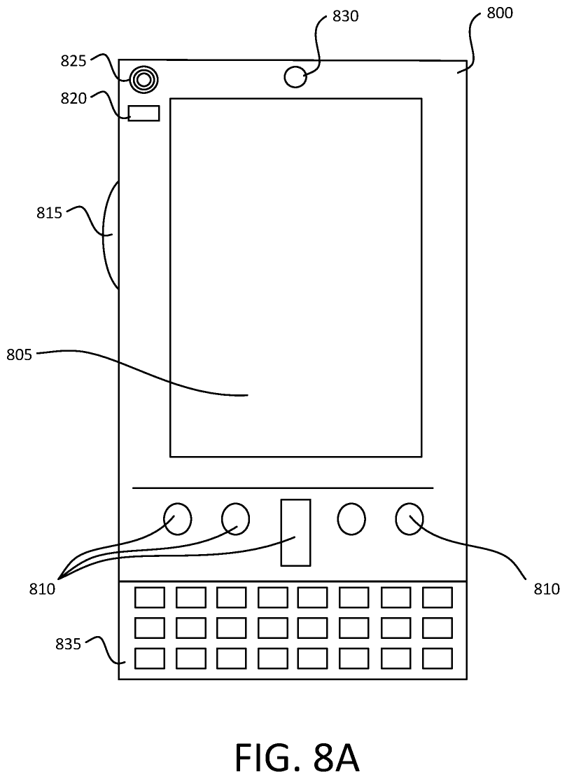

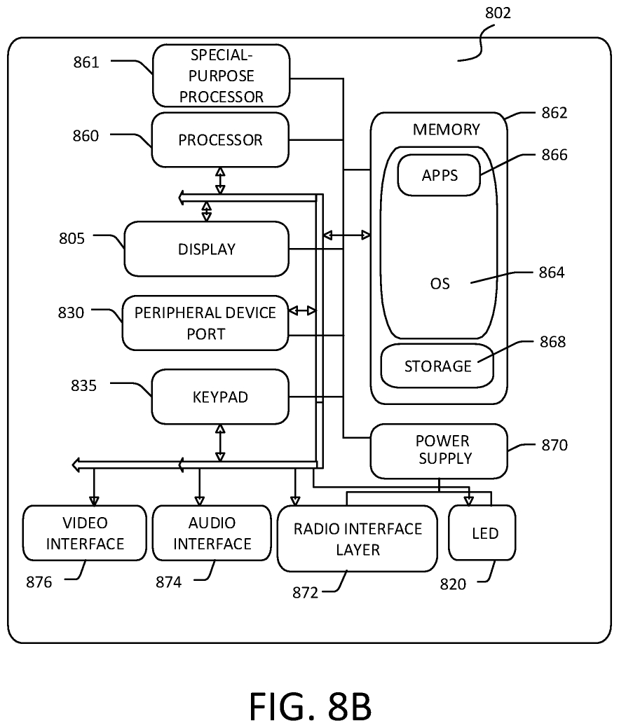

FIGS. 8A and 8B illustrate a mobile computing device 800, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 8A, one aspect of a mobile computing device 800 for implementing the aspects is illustrated. In a basic configuration, the mobile computing device 800 is a handheld computer having both input elements and output elements. The mobile computing device 800 typically includes a display 805 and one or more input buttons 810 that allow the user to enter information into the mobile computing device 800. The display 805 of the mobile computing device 800 may also function as an input device (e.g., a touch screen display).

If included, an optional side input element 815 allows further user input. The side input element 815 may be a rotary switch, a button, or any other type of manual input element. In alternative aspects, mobile computing device 800 may incorporate more or less input elements. For example, the display 805 may not be a touch screen in some embodiments.

In yet another alternative embodiment, the mobile computing device 800 is a portable phone system, such as a cellular phone. The mobile computing device 800 may also include an optional keypad 835. Optional keypad 835 may be a physical keypad or a “soft” keypad generated on the touch screen display.

In various embodiments, the output elements include the display 805 for showing a graphical user interface (GUI), a visual indicator 820 (e.g., a light emitting diode), and/or an audio transducer 825 (e.g., a speaker). In some aspects, the mobile computing device 800 incorporates a vibration transducer for providing the user with tactile feedback. In yet another aspect, the mobile computing device 800 incorporates input and/or output ports, such as an audio input (e.g., a microphone jack), an audio output (e.g., a headphone jack), and a video output (e.g., a HDMI port) for sending signals to or receiving signals from an external device.

FIG. 8B is a block diagram illustrating the architecture of one aspect of a mobile computing device. That is, the mobile computing device 800 can incorporate a system (e.g., an architecture) 802 to implement some aspects. In one embodiment, the system 802 is implemented as a “smart phone” capable of running one or more applications (e.g., browser, e-mail, calendaring, contact managers, messaging clients, games, and media clients/players). In some aspects, the system 802 is integrated as a computing device, such as an integrated personal digital assistant (PDA) and wireless phone.

One or more application programs 866 may be loaded into the memory 862 and run on or in association with the operating system 864. Examples of the application programs include phone dialer programs, e-mail programs, personal information management (PIM) programs, word processing programs, spreadsheet programs, Internet browser programs, messaging programs, and so forth. The system 802 also includes a non-volatile storage area 868 within the memory 862. The non-volatile storage area 868 may be used to store persistent information that should not be lost if the system 802 is powered down. The application programs 866 may use and store information in the non-volatile storage area 868, such as e-mail or other messages used by an e-mail application, and the like. A synchronization application (not shown) also resides on the system 802 and is programmed to interact with a corresponding synchronization application resident on a host computer to keep the information stored in the non-volatile storage area 868 synchronized with corresponding information stored at the host computer. As should be appreciated, other applications may be loaded into the memory 862 and run on the mobile computing device 800 described herein.

The system 802 has a power supply 870, which may be implemented as one or more batteries. The power supply 870 might further include an external power source, such as an AC adapter or a powered docking cradle that supplements or recharges the batteries.

The system 802 may also include a radio interface layer 872 that performs the function of transmitting and receiving radio frequency communications. The radio interface layer 872 facilitates wireless connectivity between the system 802 and the “outside world,” via a communications carrier or service provider. Transmissions to and from the radio interface layer 872 are conducted under control of the operating system 864. In other words, communications received by the radio interface layer 872 may be disseminated to the application programs 866 via the operating system 864, and vice versa.

The visual indicator 820 may be used to provide visual notifications, and/or an audio interface 874 may be used for producing audible notifications via the audio transducer 825. In the illustrated embodiment, the visual indicator 820 is a light emitting diode (LED) and the audio transducer 825 is a speaker. These devices may be directly coupled to the power supply 870 so that when activated, they remain on for a duration dictated by the notification mechanism even though the processor 860 and other components might shut down for conserving battery power. The LED may be programmed to remain on indefinitely until the user takes action to indicate the powered-on status of the device. The audio interface 874 is used to provide audible signals to and receive audible signals from the user. For example, in addition to being coupled to the audio transducer 825, the audio interface 874 may also be coupled to a microphone to receive audible input, such as to facilitate a telephone conversation. In accordance with embodiments of the present disclosure, the microphone may also serve as an audio sensor to facilitate control of notifications, as will be described below. The system 802 may further include a video interface 876 that enables an operation of an on-board camera 830 to record still images, video stream, and the like.

A mobile computing device 800 implementing the system 802 may have additional features or functionality. For example, the mobile computing device 800 may also include additional data storage devices (removable and/or non-removable) such as, magnetic disks, optical disks, or tape. Such additional storage is illustrated in FIG. 8B by the non-volatile storage area 868.

Data/information generated or captured by the mobile computing device 800 and stored via the system 802 may be stored locally on the mobile computing device 800, as described above, or the data may be stored on any number of storage media that may be accessed by the device via the radio interface layer 872 or via a wired connection between the mobile computing device 800 and a separate computing device associated with the mobile computing device 800, for example, a server computer in a distributed computing network, such as the Internet. As should be appreciated such data/information may be accessed via the mobile computing device 800 via the radio interface layer 872 or via a distributed computing network Similarly, such data/information may be readily transferred between computing devices for storage and use according to well-known data/information transfer and storage means, including electronic mail and collaborative data/information sharing systems.

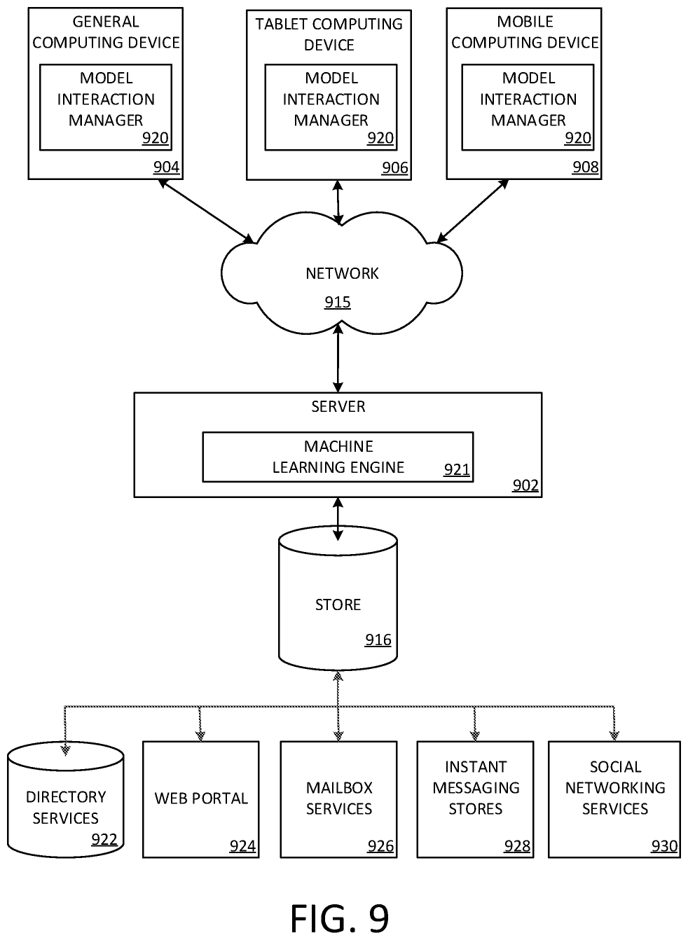

FIG. 9 illustrates one aspect of the architecture of a system for processing data received at a computing system from a remote source, such as a personal computer 904, tablet computing device 906, or mobile computing device 908, as described above. Content displayed at server device 902 may be stored in different communication channels or other storage types. For example, various documents may be stored using a directory service 922, a web portal 924, a mailbox service 926, an instant messaging store 928, or a social networking site 930.

A model interaction manager 920 may be employed by a client that communicates with server device 902, and/or machine learning engine 921 may be employed by server device 902. The server device 902 may provide data to and from a client computing device such as a personal computer 904, a tablet computing device 906 and/or a mobile computing device 908 (e.g., a smart phone) through a network 915. By way of example, the computer system described above may be embodied in a personal computer 904, a tablet computing device 906 and/or a mobile computing device 908 (e.g., a smart phone). Any of these embodiments of the computing devices may obtain content from the store 916, in addition to receiving graphical data useable to be either pre-processed at a graphic-originating system, or post-processed at a receiving computing system.

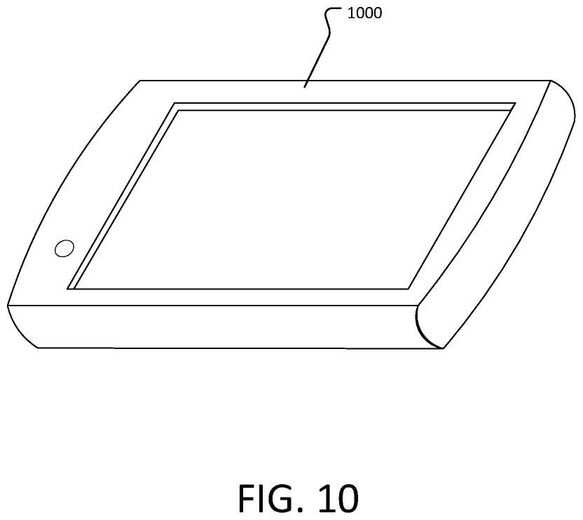

FIG. 10 illustrates an exemplary tablet computing device 1000 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use claimed aspects of the disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

1. A system comprising:
at least one processor; and
memory storing instructions that, when executed by the at least one processor, causes the system to perform a set of operations, the set of operations comprising:
obtaining source content of a source document associated with a source application;
determining, using a generative model, generated output for a target document of a target application based the source content;
receiving, via the target application, user input to modify the target document;
determining, using the generative model based on the modified target document, generated output for the source application; and
updating the source document using the generated output for the source application.

2. The system of claim 1, wherein:
the obtained source content is a subpart of the source document;
the user input is associated with a subpart of the target document; and
the source document is updated based on an association between the subpart of the target document and the subpart of the source document.

3. The system of claim 1, wherein:
the generative model is a first generative model;
the target document is a first target document;
the target application is a first target application; and
the set of operations further comprises:
determining, using a second generative model, a first generated output for a second document of a second target application based on the source content; and
based on receiving the user input to modify the first target document:
determining, using a third generative model, a second generated output for the second document based on the modified target document; and
updating the second target document using the second generated output for the second document.

4. The system of claim 3, wherein:
the first generative model is associated with the source application and the first target application;
the second generative model is associated with the source application and the second target application; and
the third generative model is associated with the first target application and the second target application.

5. The system of claim 3, wherein:
the first generative model, the second generative model, and the third generative model are the same general machine learning model; and
determining the second generated output comprises using a prompt that indicates the second generated output is for the second target application.

6. The system of claim 1, wherein updating the source document comprises executing at least a part of the generated output for the source application.

7. The system of claim 1, wherein updating the source document comprises:
displaying at least a part of the generated output for the source application;
receiving a user indication to approve the generated output for the source application; and
in response to receiving the user indication to approve the generated output, updating the source document using the generated output for the source document.

8. A method for updating a set of documents in response to user input associated with a document of the set of documents, the method comprising:
obtaining source content associated with a source application;
determining, for a target application using a generative model, generated output based on the source content;
receiving, via the target application, user input associated with the generated output;
determining, using the generative model based on the modified generated output, generated output for the source application; and
updating the source content using the generated output for the source application.

9. The method of claim 8, wherein determining the generated output further comprises:
generating an association between the generated output and the source content.

10. The method of claim 9, further comprising:
receiving a user indication to lock at least a part of the source content; and
updating the association to indicate the part of the source content is locked.

11. The method of claim 8, wherein updating the source document comprises:
displaying at least a part of the generated output for the source application;
receiving a user indication to approve the generated output for the source application; and
in response to receiving the user indication to approve the generated output, updating the source document using the generated output for the source document.

12. The method of claim 8, wherein updating the source document comprises:
displaying at least a part of the generated output for the source application;
receiving a user indication to revise the generated output for the source application; and
updating the source document using the revised generated output for the source document.

13. The method of claim 8, wherein determining the generated output comprises:
providing the obtained source content to a multimodal generative platform; and
receiving, from the multimodal generative platform, the generated content.

14. A method for updating a set of documents in response to user input associated with a document of the set of documents, the method comprising:
obtaining source content of a source document associated with a source application;
determining, using a generative model, generated output for a target document of a target application based the source content;
receiving, via the target application, user input to modify the target document;
determining, using the generative model based on the modified target document, generated output for the source application; and
updating the source document using the generated output for the source application.

15. The method of claim 14, wherein:
the obtained source content is a subpart of the source document;
the user input is associated with a subpart of the target document; and
the source document is updated based on an association between the subpart of the target document and the subpart of the source document.

16. The method of claim 14, wherein:
the generative model is a first generative model;
the target document is a first target document;
the target application is a first target application; and
the method further comprises:
determining, using a second generative model, a first generated output for a second document of a second target application; and
based on receiving the user input to modify the first target document:
determining, using a third generative model, a second generated output for the second document based on the modified target document; and
updating the second target document using the second generated output for the second document.

17. The method of claim 16, wherein:
the first generative model is associated with the source application and the first target application;
the second generative model is associated with the source application and the second target application; and
the third generative model is associated with the first target application and the second target application.

18. The method of claim 16, wherein:
the first generative model, the second generative model, and the third generative model are the same general machine learning model; and
determining the second generated output comprises using a prompt that indicates the second generated output is for the second target application.

19. The method of claim 14, wherein:
the source document and the target document are each associated with a metadocument; and
the source application processes the metadocument to generate a first representation of the metadocument that is the source document; and
the target application processes the metadocument to generate a second representation of the metadocument that is the target document.

20. The method of claim 14, wherein updating the source document comprises:
displaying at least a part of the generated output for the source application;
receiving a user indication to approve the generated output for the source application; and
in response to receiving the user indication to approve the generated output, updating the source document using the generated output for the source document.
